(19) United States
(12) Patent Application Publication
(10) Pub. No.: US 2026/0327052 A1
(43) Pub. Date: Oct. 22, 2026

(54) AUTONOMOUS MOBILE ROBOT AND LIFT UNIT

(71) Applicant: LG ELECTRONICS INC., Seoul (KR)

(72) Inventors: Sanghak LEE, Seoul (KR); Sunho YANG, Seoul (KR); Chungin JUNG, Seoul (KR); Junsin PARK, Seoul (KR); Sunuk KIM, Seoul (KR)

(73) Assignee: LG ELECTRONICS INC., Seoul (KR)

(21) Appl. No.: 19/099,400

(22) PCT Filed: Jul. 29, 2022
(86) PCT No.: PCT/KR2022/011186

§ 371 Date: Jan. 28, 2025

(51) Int. Cl. B66F 9/06; B66F 9/065

(52) U.S. Cl. CPC B66F 9/063; B66F 9/065

(57) ABSTRACT

This lift unit comprises: a lower housing; a horizontal movement portion seated on the upper surface of the lower housing; a vertical movement portion which is fastened with the horizontal movement portion and moves in the vertical direction when the horizontal movement portion is driven; and an upper housing located on the upper portion of the vertical movement portion, wherein the horizontal movement portion comprises a pair of actuators having variable lengths in opposite directions and a pair of inclination modules located at end portions of the pair of actuators, and the vertical movement portion comprises inclination rollers moving along the inclined surfaces of the inclination modules. Thus, the lift unit may transport a loaded structure while driving in the horizontal direction by using the driving force in the horizontal direction.

### TECHNICAL FIELD

The present disclosure relates to a lift unit that is mounted on a top surface of a robot for transporting one or more articles to a destination, and supports a lower portion of a loading structure while changing a vertical thickness thereof, and an autonomous mobile robot (AMR) including the same.

### BACKGROUND

To take charge of a portion of factory automation, robots have been developed for industrial use. Recently, the application range of robots has been further expanded, and robots that can be used in daily life as well as medical robots and aerospace robots are being developed.

Among industrial robots, robots that perform precise assembly work repeatedly perform the same operations and repeat the operations without encountering unexpected situations at a predetermined position, so that automation using the robots has been proceeded.

However, a transportation area including a traveling area (i.e., a driving area) where occurrence or non-occurrence of unexpected situations can be determined, has not yet been actively commercialized with robots. However, recently, as performance of sensors that recognize the surroundings has improved and computer technology that can quickly process the recognized information has evolved, the number of driving robots has rapidly increased.

Industrially, robots that are in charge of transportation functions have attracted attention and competition in robot technology is intensifying day by day. In addition to robots that transport bulky or large articles, there is a growing need for robots that perform services to transport small articles to destinations.

However, conventional goods transportation has difficulty in unloading loaded articles from a loading space to a destination. Since costs are increased when using an arm-shaped device like a person's arm, research on cheaper and more stable unloading methods capable of unloading articles is being actively conducted.

### SUMMARY

### Technical Problem

The present disclosure is to provide a lift unit that is mounted on a top surface of a robot for transporting one or more articles to a destination, and supports a lower portion of a loading structure while changing a vertical thickness thereof, and an autonomous mobile robot (AMR) including the same.

### Technical Solutions

Provided is a lift unit including a lower housing, a horizontally moveable structure seated on a top surface of the lower housing, a vertically moveable structure fastened to the horizontally moveable structure and moveable in a vertical direction when the horizontally moveable structure is operated, and an upper housing positioned on the vertically moveable structure, wherein the horizontally moveable structure includes a pair of actuators with lengths changing in opposite directions, and a pair of inclination modules positioned at ends of the pair of actuators, respectively, wherein the vertically moveable structure includes an inclination roller moveable along an inclined surface of each inclination module.

The pair of inclination modules may include the inclined surfaces directed in opposite directions, respectively, and the lift unit may include a slide roller in contact with the lower housing.

The vertically moveable structure may further include a roller bracket protruding toward the inclined surface of each inclination module and having the inclination roller coupled to an end thereof.

The vertically moveable structure may include a pair of vertical guide rollers rotatable about respective shafts thereof parallel to each other, and the lift unit may include a vertical guide block coupled to the lower housing and positioned between the pair of vertical guide rollers.

The vertical guide block may include a first guide block fixed to the lower housing, and a second guide block including a vertical guide rail engaged with each vertical guide roller and rotatably coupled to the first guide block.

The first guide block and the second guide block may be coupled to each other to be rotatable about a direction perpendicular to an extension direction of each actuator.

The lift unit may further include a controller that operates the pair of actuators, the controller may independently control the length changes of the pair of actuators.

The lift unit may further include a posture sensor that senses an inclination of the lower housing, and the controller may control the pair of actuators such that the upper housing is inclined with respect to the lower housing in a direction opposite to a direction of the lower housing inclined with respect to a gravitational direction.

The upper housing may further include a docking guide pin positioned on a top surface thereof.

The upper housing may further include a docking guide roller protruding from a corner thereof.

The lift unit may further include a bottom slide roller positioned on a bottom surface of each inclination module and in contact with the lower housing.

The lower housing may include a horizontal guide rail positioned on a lateral side relative to a movement direction of each inclination module, and the lift unit may include a side slide roller positioned on the lateral side of each inclination module and in contact with the horizontal guide rail.

Provided is an autonomous mobile robot including a body including a driving unit, and a lift unit positioned on top of the body and having a height adjustable in a vertical direction, the lift unit includes a lower housing coupled to an upper portion of the body, a horizontally moveable structure seated on a top surface of the lower housing, a vertically moveable structure fastened to the horizontally moveable structure and moveable in a vertical direction when the horizontally moveable structure is operated, and an upper housing positioned on the vertically moveable structure, wherein the horizontally moveable structure includes a pair of actuators with lengths changing in opposite directions, and a pair of inclination modules positioned at ends of the pair of actuators, respectively, wherein the vertically moveable structure includes an inclination roller moveable along an inclined surface of each inclination module.

### Advantageous Effects

The lift unit according to the present disclosure may transport the loading structure while operating in the horizontal direction using the driving force in the horizontal direction.

The transport robot is able to transport another loading structure even during the time when the article is unloaded after transport of the loading structure, so that efficiency may be improved.

In addition, the upper housing does not ascend obliquely but moves in the vertical direction to uniformly support the load, so that the weight of the loading structure may be stably transported.

Even on the oblique inclined surface, the top surface of the lift unit may be maintained horizontal, thereby preventing the article from falling during the transportation.

Effects obtainable from the present embodiments are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a diagram illustrating a cloud system based on a 5G network according to an embodiment of the present disclosure.

FIG. 2 is a block diagram illustrating a configuration of an autonomous mobile robot according to an embodiment of the present disclosure.

FIG. 3 is a diagram illustrating a robot control system according to an embodiment of the present disclosure.

FIG. 4 is a perspective view according to an embodiment of an autonomous mobile robot of the present disclosure.

FIG. 5 is a view showing an operating aspect of a lift unit according to the present disclosure.

FIG. 6 is a diagram illustrating a process in which a transport robot according to the present disclosure docks with a loading structure.

FIG. 7 is an exploded perspective view of a lift unit according to the present disclosure.

FIG. 8 is a perspective view illustrating a horizontally moveable structure coupled to a base plate of a lift unit according to the present disclosure.

FIG. 9 is a view illustrating a state in which a vertically moveable structure is coupled to a structure in FIG. 8.

FIG. 10 is a cross-sectional view taken along a line A-A in FIG. 9.

FIG. 11 is a cross-sectional view taken along a line B-B in FIG. 9.

FIG. 12 is a view illustrating a vertical guide module of a lift unit according to the present disclosure.

FIG. 13 is a view showing asymmetric operation of a lift unit according to the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot may perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot may perform various physical operations, such as moving a robot joint.

Industrial robots or medical robots having a specialized appearance for specific tasks due to problems such as high manufacturing costs and dexterity of robot manipulation were the first to be developed.

Whereas industrial and medical robots are configured to repeatedly perform the same operation in a designated place, mobile robots have recently been developed and introduced to the market. Robots for use in the aerospace industry may perform exploration tasks or the like on distant planets that are difficult for humans to directly go to, and such robots have a driving function.

In order to perform the driving function, the robot has a driver, wheel(s), a frame, a brake, a caster, a motor, etc. In order for the robot to recognize the presence or absence of surrounding obstacles and move while avoiding the surrounding obstacles, an evolved robot equipped with artificial intelligence has recently been developed.

Artificial intelligence refers to a technical field for researching artificial intelligence or a methodology for implementing the artificial intelligence. Machine learning refers to a technical field for defining various problems handled in the artificial intelligence field and for researching methodologies required for addressing such problems. Machine learning is also defined as an algorithm that improves performance of a certain task through continuous experience.

An artificial neural network (ANN) is a model used in machine learning, and may refer to an overall model having problem solving ability, which is composed of artificial neurons (nodes) that form a network by a combination of synapses. The artificial neural network (ANN) may be defined by a connection pattern between neurons of different layers, a learning process of updating model parameters, and an activation function of generating an output value.

The artificial neural network (ANN) may include an input layer and an output layer, and may optionally include one or more hidden layers. Each layer includes one or more neurons, and the artificial neural network (ANN) may include a synapse that interconnects neurons and other neurons.

In the artificial neural network (ANN), each neuron may output a function value of an activation function with respect to input signals received through synapses, weights, and deflection.

A model parameter may refer to a parameter determined through learning, and may include the weight for synapse connection and the deflection of neurons. In addition, the hyperparameter refers to a parameter that should be set before learning in a machine learning algorithm, and includes a learning rate, the number of repetitions, a mini-batch size, an initialization function, and the like.

The purpose of training the artificial neural network (ANN) may be seen as determining model parameters that minimize a loss function according to the purpose of the robot or the field of use of the robot. The loss function may be used as an index for determining an optimal model parameter in a learning process of the artificial neural network (ANN).

Machine learning may be classified into supervised learning, unsupervised learning, and reinforcement learning according to learning methods.

Supervised learning refers to a method for training the artificial neural network (ANN) in a state where a label for learned data is given. Here, the label may refer to a correct answer (or a resultant value) that should be inferred by the artificial neural network (ANN) when the learned data is input to the artificial neural network (ANN). Unsupervised learning may refer to a method for training the artificial neural network (ANN) in a state where a label for learned data is not given. Reinforcement learning may refer to a learning method in which an agent defined in the certain environment learns to select an action or sequence of actions that may maximize cumulative compensation in each state.

Among artificial neural networks, machine learning implemented as a deep neural network (DNN) including a plurality of hidden layers is also referred to as deep learning, and deep learning is a part of machine learning. Hereinafter, machine learning is used in a sense including deep learning.

Artificial intelligence (AI) technology is applied to the robot, so that the robot may be implemented as a guide robot, a autonomous mobile robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a driving path and a driving plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot may perform a necessary operation by directly generating a result using the learning model, the robot may also perform an operation by transmitting sensor information to an external device such as an AI server and receiving the resultant information generated thereby.

The robot may perform autonomous driving through artificial intelligence. Autonomous driving refers to a technique in which a movable object such as a robot may autonomously determine an optimal path by itself and may move while avoiding collision with an obstacle. The autonomous driving technique currently being applied may include a technique in which the movable object (e.g., a robot) may travel while maintaining a current driving lane, a technique in which the movable object may travel while automatically adjusting a driving speed such as adaptive cruise control, a technique in which the movable object may automatically travel along a predetermined path, and a driving technique in which, after a destination is decided, a path to the destination is automatically set.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a Lidar, a radar, and the like.

The robot may perform autonomous driving not only based on information collected by sensors, but also based on image information collected by an RGBC camera and an infrared (IR) camera and sound information collected through a microphone. In addition, the robot may travel based on information received through a user input unit. Map data, position information, and information about peripheral situations may be collected through a wireless communication unit. The collected information is requisite for autonomous driving.

Map data may include object identification information for various objects disposed in a space where the robot moves. For example, the map data may include object identification information for fixed objects such as a wall and a door, and other object identification information for movable objects such as a flowerpot and a desk. In addition, the object identification information may include a name, a type, a distance, a location, etc.

Therefore, the robot may essentially include sensors, various input units, a wireless communication unit, and the like to collect data that may be learned by artificial intelligence, and may perform optimal operations by synthesizing various types of information. The learning processor for performing artificial intelligence may perform learning by being mounted in a controller embedded in the robot, may transmit the collected information to a server, may perform learning through the server, and may retransmit the learned result to the robot, so that the robot may perform autonomous driving based on the learned result.

A robot equipped with artificial intelligence may collect the surrounding information even in a new place to implement the entire map, and a large amount of information about a place of the major activity zone may be accumulated, so that the robot may perform more accurate autonomous driving.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

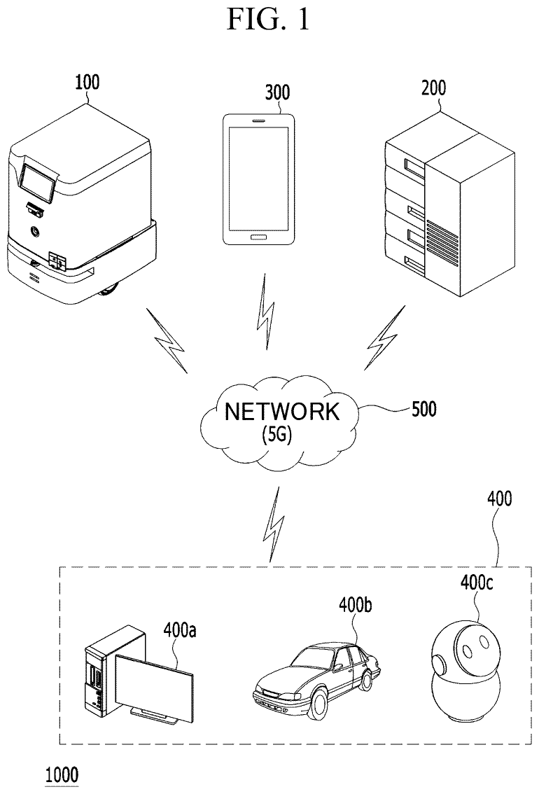

FIG. 1 is a diagram illustrating a cloud system 1000 based on a 5G network according to an embodiment of the present disclosure.

Referring to FIG. 1, the cloud system 1000 may include a autonomous mobile robot 100, a mobile terminal 300, a robot control system 200, various devices 400, and a 5G network 500.

The autonomous mobile robot 100 is a robot that transports goods (articles) from a departure point to a destination. The autonomous mobile robot 100 can move directly from a logistics center to a destination. Alternatively, after the autonomous mobile robot is loaded on a vehicle at the logistics center and is then delivered to the vicinity of the destination by the vehicle, the autonomous mobile robot is unloaded from the vehicle and then moves to the destination.

In addition, the autonomous mobile robot 100 may move articles to the destination not only outdoors but also indoors. The autonomous mobile robot 100 can be implemented as an AGV, and the AGV may be a transport device that moves by a sensor, a magnetic field, a vision device, etc. on the floor.

The autonomous mobile robot 100 may include a storage area for storing articles therein, the storage area may be divided into a plurality of partial storage areas to load various articles, and various types of articles may be placed in the partial storage areas. Accordingly, mixing of articles can be prevented.

The mobile terminal 300 may communicate with the autonomous mobile robot 100 via the 5G network 500. The mobile terminal 300 may be a device carried by a user who installs a partition in the storage area to load articles, or may be a device carried by a recipient of the loaded articles. The mobile terminal 300 may provide information based on images, and the mobile terminal 300 may include mobile devices such as a mobile phone, a smartphone, a wearable device (e.g., a watch-type terminal, a glass-type terminal, an HMD).

The robot control system 200 may remotely control the autonomous mobile robot 100 and respond to various requests of the autonomous mobile robot 100. For example, the robot control system 200 may perform calculations using artificial intelligence (AI) based on the request from the autonomous mobile robot 100.

In addition, the robot control system 200 may determine a movement path of the autonomous mobile robot 100. When there is a plurality of destinations, the robot control system 200 may determine the order of the destinations when there are multiple destinations.

The various devices 400 may include a personal computer (PC) 400a, an autonomous vehicle 400b, a home robot 400c, etc. When the autonomous mobile robot 100 arrives at the transport destination of the articles, the autonomous mobile robot 100 can directly deliver the articles to the home robot 400c through communication with the home robot 400c.

The various devices 400 may be connected to the autonomous mobile robot 100, the mobile terminal 300, the robot control system 200, etc., via the 5G network 500 by wire or wirelessly.

The autonomous mobile robot 100, the mobile terminal 300, the robot control system 200, and various devices 400 are all equipped with 5G modules to transmit and receive data at a rate of 100 Mbps to 20 Gbps (or higher), so that large video files can be transmitted to various devices, and power consumption can be minimized by operating at low power. However, the transfer rate may be implemented differently depending on the embodiments.

The 5G network 500 may include a 5G mobile communication network, a short-range network, the Internet, etc., and may provide a communication environment for devices by wire or wirelessly.

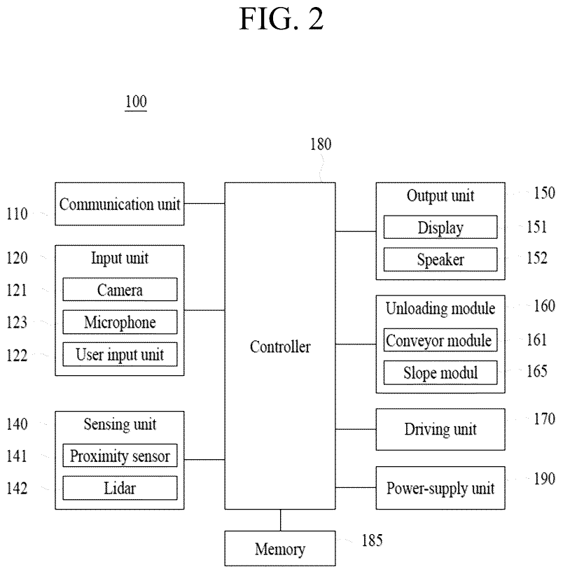

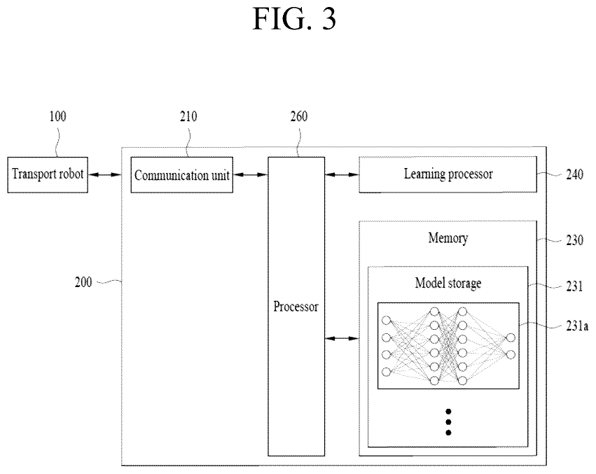

FIG. 2 is a block diagram illustrating appearance of the autonomous mobile robot 100 according to an embodiment of the present disclosure. The autonomous mobile robot 100 according to an embodiment of the present disclosure will be described with reference to FIGS. 3 to 5.

Referring to FIG. 2, the autonomous mobile robot 100 may include a body including a storage area 50, and constituent components to be described later may be included in the body. The autonomous mobile robot 100 may include a communication unit 110, an input unit 120, a sensor unit 140, an output unit 150, a memory 185, a wheel driving unit 170, a controller 180, and a power-supply unit 190. The constituent components shown in FIG. 2 are not always required to implement the autonomous mobile robot 100, such that it should be noted that the autonomous mobile robot 100 according to the present disclosure may include more or fewer components than the elements listed above.

The communication unit 110 may include a wired or wireless communication module capable of communicating with the robot control system 200.

As an optional embodiment, the communication unit 110 may be equipped with modules for GSM, CDMA, LTE, 5G, WLAN, Wi-Fi, Bluetooth, RFID, infrared communication (IrDA), ZigBee, and NFC communication.

The input unit 120 may include a user input unit 122 for receiving information from a user. As an optional embodiment, the input unit 120 may include a camera 121 for inputting an image signal, and a microphone 123 (hereinafter referred to as a “microphone”) for receiving an audio signal. Here, the camera 121 or the microphone 123 may be treated as a sensor, and a signal acquired from the camera 121 or the microphone 123 may be referred to as sensing data or sensor information.

The input unit 120 may acquire input data to be used when acquiring output data using learning data and a learning model for model learning. The input unit 120 may obtain unprocessed input data. In this case, the controller 180 may extract input feature points as preprocessing for the input data.

The camera 121 may be located in front to detect obstacles in front, and as shown in FIG. 3, a plurality of cameras 121 may be arranged to be different in angle. In more detail, the plurality of cameras 121 may have different capture directions, such as a camera for widely recognizing a front-view area and a camera for capturing a floor.

Alternatively, cameras with different functions may be provided. For example, a wide-angle camera, an infrared (IR) camera, etc. may be provided. The camera may serve as a sensor unit 140 for detecting surrounding objects.

The user input unit 122 may be provided with a touch panel overlapping with a button or a display 151. Alternatively, a user command may be input remotely through the communication unit 110. In this case, the user input unit 122 may include a PC 400 or a remote control device separately provided from the autonomous mobile robot 100.

Since the user input unit 122 includes all methods capable of receiving user commands, the user input unit 122 can recognize user commands through voice recognition. That is, a voice recognition device that analyzes voice collected from the microphone 123 and extracts user commands can also serve as the user input unit 122.

The input unit 120 may include an article information input unit, and the article information input unit may receive information about the article's size, information about the article's weight, destination information, information about a transport requester, etc. At this time, the article information input unit may include a code reader.

The sensor unit 140 may obtain at least one of internal information of the autonomous mobile robot 100, surrounding environment information of the autonomous mobile robot 100, and user information using various sensors.

At this time, the sensor unit 140 may include various types of sensors for recognizing the surroundings for autonomous driving. Representative examples may include a distance detection sensor or a proximity sensor 141 and a Lidar 141.

The proximity sensor 141 may include an ultrasonic sensor that recognizes nearby objects and determines the distance to the objects based on the time taken for emitted ultrasonic waves to return. A plurality of proximity sensors may be provided along the circumference, and may also be provided on an upper side to detect obstacles located on the upper side.

The Lidar 142 is a device that precisely expresses exterior appearances of the surroundings by emitting laser pulses and receiving the light that is reflected from the surrounding objects. The operation principle of the Lidar 142 is similar to that of a radar, but different electromagnetic waves are used in the Lidar 142 and the radar, so that the Lidar 142 and the radar are designed to use different technologies and different utilization ranges.

Lasers may damage human eyesight because they use light with a wavelength of 600 to 1000 nm. The Lidar 142 uses a longer wavelength than the lasers, and is used to measure not only the distance to a target object, but also a moving speed and direction, temperature, surrounding atmospheric material analysis, a concentration measurement, and the like.

In addition, the sensor unit 140 may include an illumination sensor, an acceleration sensor, a magnetic sensor, a gyro sensor, an inertial sensor, an RGB sensor, an infrared (IR) sensor, a fingerprint recognition sensor, an ultrasonic sensor, a light sensor, an optical sensor, etc.

The output unit 150 may generate various output signals related to visual, auditory and/or tactile sensations. The output unit 150 may include an optical output unit that outputs visual information, a display 151, etc. The output unit 150 may include a speaker 152 for outputting auditory information, an ultrasonic output unit for outputting ultrasonic signals belonging to an inaudible frequency, etc., and a haptic module for outputting tactile information.

The memory 185 may store data that supports various functions of the autonomous mobile robot 100. The memory 185 may store not only a plurality of application programs (or applications) driven by the autonomous mobile robot 100, but also data and commands required to operate the autonomous mobile robot 100.

In addition, the memory 185 may store information required to perform operations using artificial intelligence, machine learning, and artificial neural networks. The memory 185 may store a deep neural network model. The deep neural network model may be used to infer a result value for new input data rather than learning data, and the inferred value may be used as a basis of determination required to perform a certain operation.

The power-supply unit 190 may receive external power or internal power under control of the controller 180, such that the power-supply unit 190 may supply the received power to the constituent components included in the autonomous mobile robot 100. The power-supply unit 190 may include, for example, a battery. The battery 191 may be implemented as an embedded battery or a replaceable battery. The battery may be charged by a wired or wireless charging method, and the wireless charging method may include a magnetic induction method or a magnetic resonance method.

The driving unit 170 is a means for moving the autonomous mobile robot 100, may include wheels or legs, and may include a wheel driving unit and a leg driving unit for controlling the wheels or legs.

A plurality of wheels provided on the bottom surface of the wheel driving unit may be controlled to move the autonomous mobile robot 100 including the body. The wheels may include a main wheel 171 for fast driving, a caster 173 for changing the direction to another direction, and an auxiliary caster for stable driving so that the loaded articles (L) do not fall during driving.

The leg driving unit (not shown) may control multiple legs according to control of the controller 180, and may thus move the body. The plurality of legs may correspond to a configuration formed so that the autonomous mobile robot 100 can walk or run. The plurality of legs may be implemented as four legs, but the scope of the present disclosure is not limited thereto. The plurality of legs may be coupled to the body to be integrally formed, and may be implemented to be detachably coupled to the body.

The autonomous mobile robot 100 may move the body through the driving unit 170 having at least one of the wheel driving unit and/or the leg driving unit. However, in this specification, an example in which the wheel driving unit is mounted on the autonomous mobile robot 100 will be mainly described.

The controller 180 is a module that controls the configurations of the autonomous mobile robot 100. The controller 180 may refer to a data processing device embedded in hardware that has a physically structured circuit to perform a function expressed by code or commands included in a program. As an example of the data processing device embedded in hardware, this exemplary data processing device may include processing devices such as a microprocessor, a central processing unit (CPU), a processor core, a multiprocessor, an ASIC, and an FPGA, but the scope of the present disclosure is not limited thereto.

For example, the controller 180 may collect the above information through the input unit 120. The input of the input unit 120 may also include a touch input on the display.

Based on the collected information, the controller 180 may transmit information on the articles (L) loaded in the loading area 50 to the mobile terminal 200 (see FIG. 1) through the communication unit 110.

Referring to FIG. 3, the robot control system 200 may include an artificial intelligence (AI) server. The AI server may mean a device that uses a machine learning algorithm to train an artificial neural network or uses a trained artificial neural network. Here, the robot control system 200 may include a plurality of servers to perform distributed processing, and may be defined as a 5G network. At this time, the AI server may be included as a part of the configuration of the autonomous mobile robot 100, and may also enable the autonomous mobile robot 100 to perform at least a part of the AI processing.

The robot control system 200 may include a communication unit 210, a memory 230, a learning processor 240, a processor 260, etc.

The communication unit 210 may transmit and receive data to and from an external device such as the autonomous mobile robot 100.

The memory 230 may include a model storage unit 231. The model storage unit 231 may store a learning or learned model (or an artificial neural network 231a) through the learning processor 240.

The learning processor 240 may train (or learn) the artificial neural network 231a using training data (also called learning data). The learning model may be used while being loaded into the robot control system 200 of the artificial neural network, or may be loaded into an external device such as the autonomous mobile robot 100 and then used.

The learning model may be implemented as hardware, software, or a combination of hardware and software. If all or some of the learning model are implemented as software, one or more commands constituting the learning model can be stored in the memory 230.

The processor 260 may infer a result value for new input data using the learning model, and may generate a response or control command based on the inferred result value.

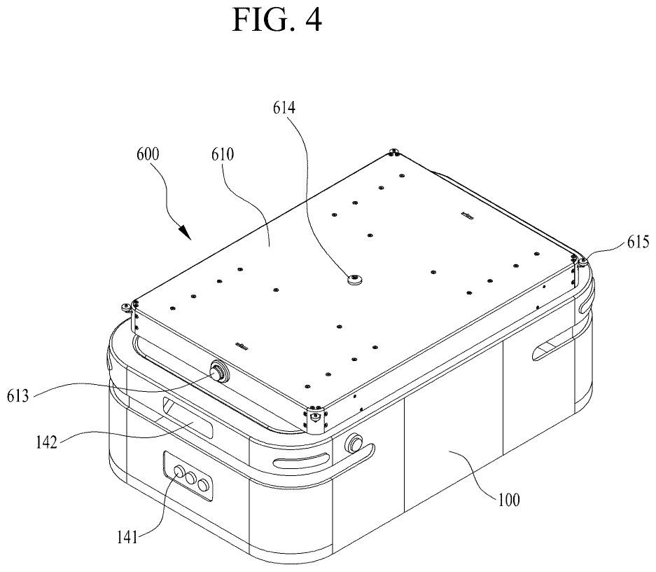

FIG. 4 is a perspective view according to an embodiment of the autonomous mobile robot 100 of the present disclosure.

The autonomous mobile robot 100 according to the present disclosure may move via the driving unit 170 located beneath a body 101. The main body of the autonomous mobile robot 100 may have a box shape, and may have a top surface with a predetermined area size to mount a lift unit 600 thereon.

The driving unit 170, the power supply unit 190, the controller 180, the sensing unit 140, and the like may be mounted on the flat box-shaped body 101. The controller 180 may generate a travel path to reach a destination using a map stored in advance or received from a server and the sensor unit 140 may recognize a surrounding object, so that the robot may move to the destination by avoiding an obstacle not on the map.

The LiDAR 142 and the proximity sensor may be located in the body 101. Because the LiDAR 142 has a wide sensing range, as shown in FIG. 4, the LiDAR 142 may include a groove elongated in a horizontal direction to expand the sensing range thereof. A plurality of proximity sensors 141 may be positioned along a periphery of the body 101 to precisely sense a location.

The autonomous mobile robot 100 according to the present disclosure may have the lift unit 600 seated on a top surface thereof. The lift unit 600 may have a thin box shape and may have a flat top surface to lift a lower portion of a loading structure 10 capable of loading an article 20 such as a shelf, a pallet cart, and the like on the top surface thereof.

A docking guide roller 615 that guides the lift unit 600 to be located at an accurate location when docking at the lower portion of the loading structure 10 may be located at an edge of an upper housing 610. For example, as illustrated in FIG. 4, the docking guide roller 615 may be located at a corner of the upper housing 610.

In addition, a docking guide uneven structure 614 engaged with the lower portion of the loading structure 10 to align the location may be included on the top surface. The docking guide uneven structure having a protruding shape (a docking guide pin) 614 is illustrated in FIG. 4. When the docking guide uneven structure 614 having a groove shape rather than the protruding shape is defined, the loading structure 10 without a guide structure corresponding to the docking guide uneven structure 614 may also be lifted on the lift unit 600.

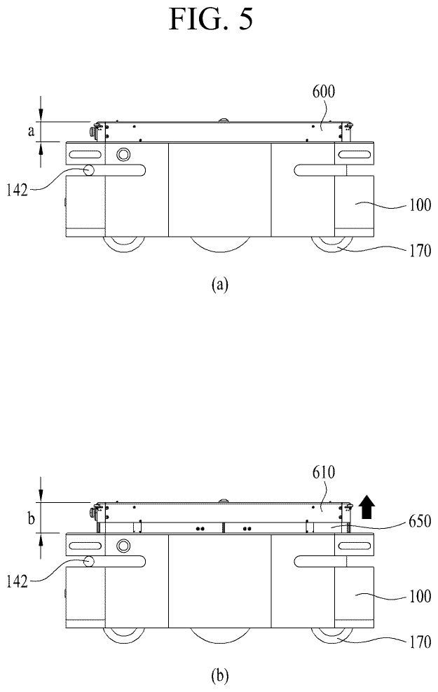

FIG. 5 is a view showing an operating aspect of the lift unit 600. From a state in which a vertical level of the lift unit 600 is low as shown in (a), the vertical level of the lift unit 600 may be increased as shown in (b) (a->b). As the upper housing 610 of the lift unit 600 moves upward while being spaced apart from the lower housing 650, a thickness of the lift unit 600 may increase.

The lift unit 600 may include drivers 620 and 630 therein for the vertical level change, and may include an emergency switch 613 for resetting when the drivers 620 and 630 malfunction.

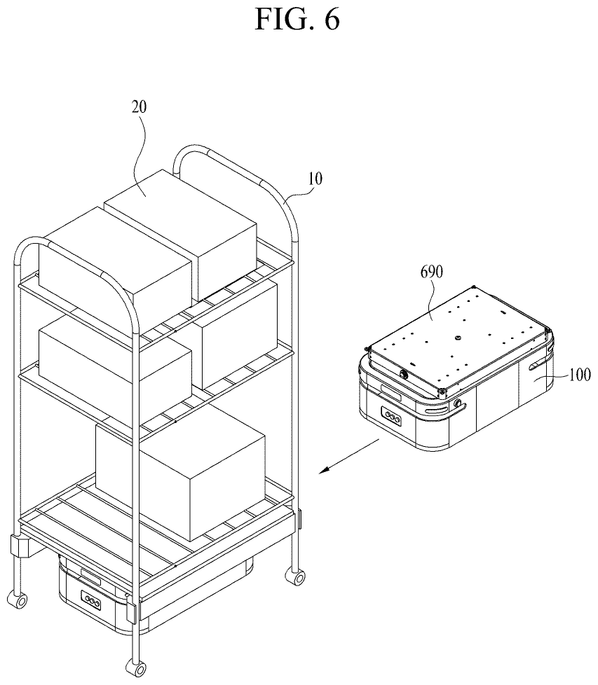

FIG. 6 is a diagram illustrating a process in which the autonomous mobile robot 100 according to the present disclosure docks with the loading structure 10. As illustrated in FIG. 6, after the autonomous mobile robot 100 moves beneath the loading structure 10 such as the shelf, the pallet cart, and the like, a vertical level of the upper housing 610 may be increased to allow a top surface 611 to be in contact with a bottom surface of the loading structure 10, thereby lifting the loading structure 10.

When the loading structure 10 has wheels, the robot may be moveable while the wheels are in contact with the ground. However, for stable travel, the vertical level of the upper housing 610 may be increased until the loading structure 10 is separated from the ground.

To find a location beneath the loading structure 10, the sensor unit 140 of the autonomous mobile robot 100 may be used, and the lift unit 600 may be controlled by receiving location information from the autonomous mobile robot 100.

The autonomous mobile robot 100 may move to the destination while the loading structure 10 is mounted on top of the lift unit 600, and may move away from beneath the loading structure 10 after lowering the vertical level of the lift unit 600 at the destination as shown in (a) in FIG. 5 again.

When the loading structure 10 and the autonomous mobile robot 100 are individually constructed as such, the autonomous mobile robot 100 may continue to transport even during a time when the article is loaded or unloaded, so that an amount of articles that may be transported by one autonomous mobile robot 100 may be increased.

Because the lift unit 600 should be designed to withstand a weight equal to or greater than 300 kg, a great load may be applied when an actuator supports a force in a vertical direction, and a height of the lift unit 600 may increase when the actuator is disposed in the vertical direction.

According to the present disclosure, the upper housing 610 may be moved in the vertical direction using a horizontally moveable structure 630 including an actuator 632 moveable in the horizontal direction to adjust a thickness of the lift unit 600.

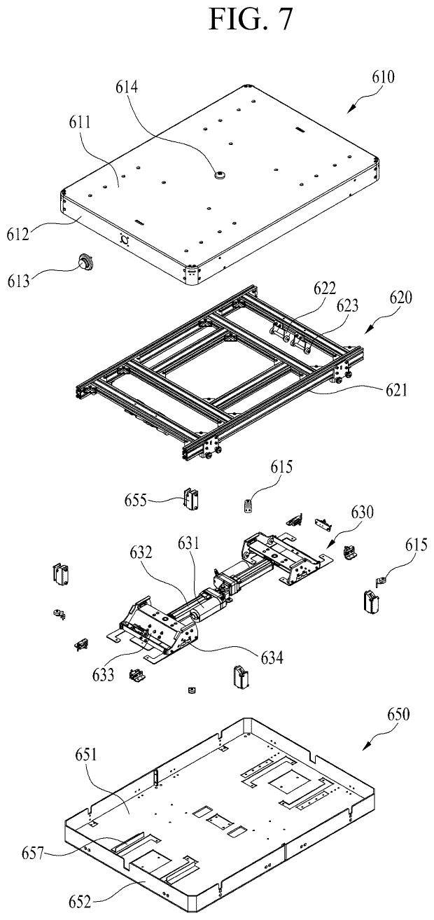

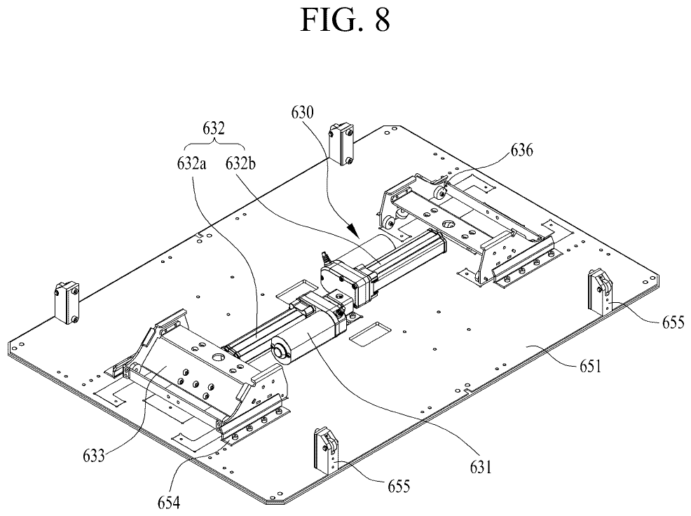

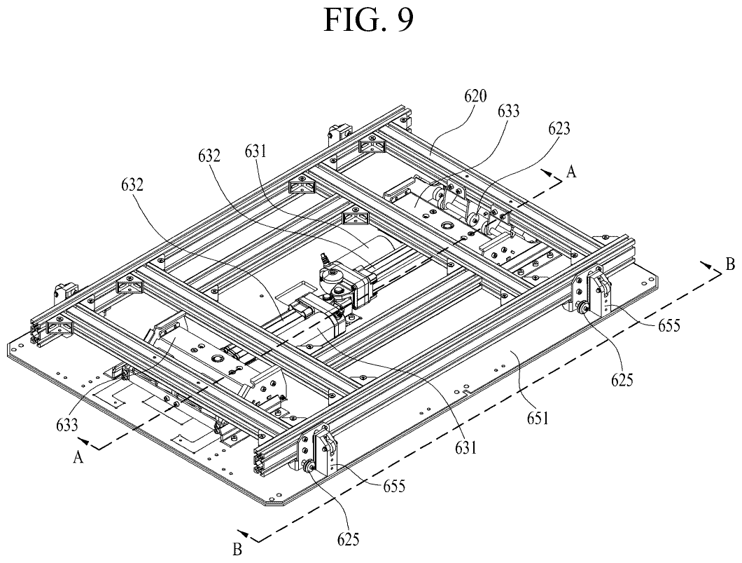

FIG. 7 is an exploded perspective view of the lift unit 600 according to the present disclosure, FIG. 8 is a perspective view illustrating the horizontally moveable structure 630 coupled to a base plate, and FIG. 9 is a view illustrating a state in which a vertically moveable structure 620 is also coupled.

The lift unit 600 may include the lower housing 650 and the upper housing 610 forming an outer appearance thereof. The lower housing 650 may be fixed to an upper portion of the autonomous mobile robot 100, and the upper housing 610 may be spaced apart from the lower housing 650 to define an internal space and may be located above the lower housing 650.

The upper housing 610 may include the top surface 611 and a first side portion 612 that support the bottom surface of the loading structure 10. The lower housing 650 may include a base plate 651 on which a horizontal driver is seated and a second side portion 652 surrounding a periphery of the base plate 651.

In the state in which the lift is thin, the first side portion 612 of the upper housing 610 and the second side portion 652 of the lower housing 650 may overlap each other, and when the upper housing 610 moves upward as shown in (b) in FIG. 5, the second side portion 652 of the lower housing 650 may be exposed.

In the space between the upper housing 610 and the lower housing 650, the vertically moveable structure 620 that vertically moves the upper housing 610 and the horizontally moveable structure 630 that provides power to the vertically moveable structure 620 are positioned.

The vertically moveable structure 620 may implement a moving frame 621 using a metal beam so as to have rigidity capable of supporting the loading structure 10 while transmitting the force of the horizontally moveable structure 630 to the upper housing 610 in a form of a frame. The rigidity may be further secured by intersecting a plurality of metal beams in different directions. The horizontally moveable structure 630 may be fastened to the vertically moveable structure 620 and may directly provide the force in the vertical direction for the vertical movement of the vertically moveable structure 620, but because the lift unit 600 is thin, it is spatially insufficient to place the actuator 632 that directly applies the force in the vertical direction.

The actuator 632 may be placed to provide the force in the horizontal direction, and an inclination module 633 that may convert the force in the horizontal direction of the actuator 632 into the vertical force may be included. The inclination module 633 may include an inclined surface obliquely facing upward and may be coupled to an end of the actuator 632.

The inclination module 633 may convert the force movement in the horizontal direction of the actuator 632 into the vertical movement.

The vertical moving portion 620 may include an inclination roller 623 positioned on the inclined surface of the inclination module 633, and the inclination roller may protrude from a lower portion of the moving frame 621. A roller bracket 622 connecting the moving frame 621 with the inclination roller 623 to transmit the force to the moving frame 621 may extend in a direction perpendicular to the inclined surface of the inclination module 633.

Although only one actuator 632 may be disposed, a pair of symmetrically disposed actuators may be disposed to move the moving frame 621 in the vertical direction without inclination. In the present embodiment, the actuator 632 may include a first actuator 632a extending forward and a second actuator 632b extending rearward.

Because the pair of actuators 632 are disposed, a pair of inclination modules 633 may also be positioned, and inclination rollers may also be positioned on front and rear surfaces of the moving frame 621, respectively.

Because movement directions of the pair of actuators 632 are different from each other, the inclined surface of the inclination module 633 connected to the first actuator 632a may face upward at a front side, and the inclined surface of the inclination module 633 connected to the second actuator 632b may face upward at a rear side.

Directions of both of the forces of the pair of actuators 632 extending in the different directions may be converted into the upward direction.

The actuator 632 may be hydraulic, pneumatic, or electric, and there may also be electro-pneumatic and electro-hydraulic actuators 632 that combine these methods.

The pneumatic type is to operate a piston in a cylinder by compressing and expanding air, and is inexpensive and easy to maintain. The hydraulic type is to operate the piston in the cylinder by a hydraulic pressure, and is able to easily obtain a high-speed response, but is expensive and requires space.

The electric type has a high degree of positioning and is able to obtain a great capacity output with a small structure. Although the electric type is more expensive and complex than the pneumatic type, it is easy to adjust the speed and output and the electric type has a small size, so that the electric actuator 632 is applied in the present embodiment.

The actuator 632 of the present embodiment may include a motor 631 that provides a rotational force and a screw shaft that rotates by receiving the rotational force of the motor 631. When the screw shaft rotates, an expandable portion may move along the screw shaft and thus a length of the actuator 632 may be changed.

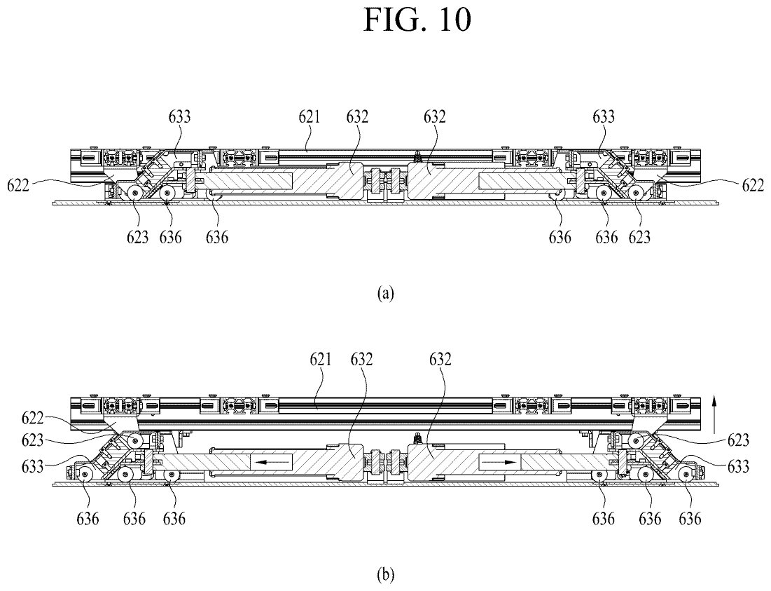

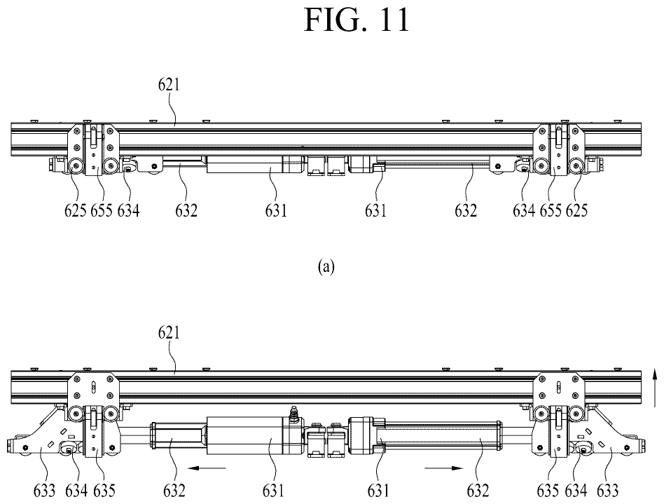

FIG. 10 is a cross-sectional view taken along a line A-A in FIG. 9, and FIG. 11 is a cross-sectional view taken along a line B-B in FIG. 9. FIG. 10 is a cross-sectional view of a portion where the inclination module 633 is visible, and FIG. 11 is a side view of the vertically moveable structure 620 and the horizontally moveable structure 630 in a state in which the housing is removed.

(a) is a view showing a state in which the lift is thin, and (b) is a view showing a state (a lift mode) in which the horizontally moveable structure 630 and the vertically moveable structure 620 move to increase the thickness of the lift. When the actuator 632 is elongated, the pair of inclination modules 633 move in different directions, and the inclination roller of the vertically moveable structure 620 moves along the inclined surface of the inclination module 633 to lift the moving frame 621 upward.

The inclination module 633 may include a slide roller so as to move based on the change in the length of the actuator 632. A bottom slide roller 636 that is in contact with the lower housing 650 and guides the movement in the horizontal direction may be disposed (see FIG. 10).

To prevent the inclination module 633 from shaking in a left and right direction rather than the extension direction of the actuator 632, horizontal guide rails 657 positioned at left and right sides of the inclination module 633 may be included (see FIG. 8).

The horizontal guide rail 657 may be coupled to the base plate 651 of the lower housing 650, and as illustrated in FIG. 11, the horizontally moveable structure 630 may include a side slide roller 634 in contact with the horizontal guide rail 657.

A vertical guide module for restricting the shaking in the horizontal direction and allowing only the vertical movement such that the vertical moving unit 620 may move in the vertical direction without moving in the horizontal direction may be further included. In the present embodiment, the vertical guide module may be located at each of left and right ends of the moving frame 621 as shown in FIG. 11.

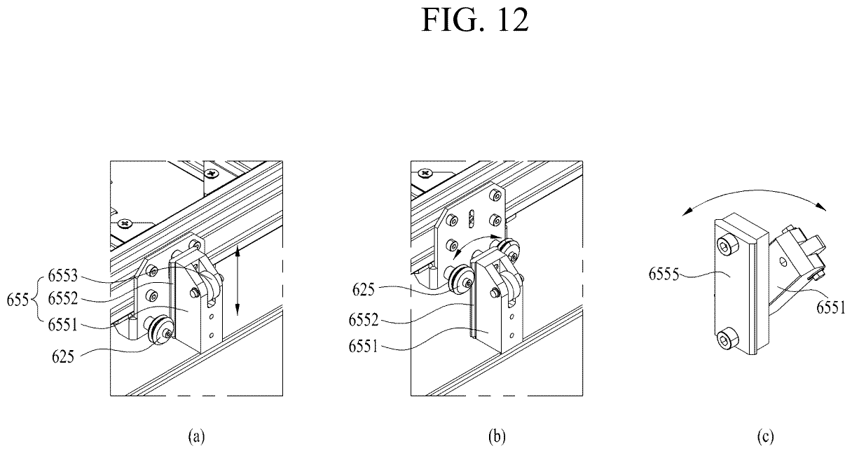

A plurality of vertical guide modules may be disposed, and in the present embodiment, as shown in FIG. 9, four vertical guide modules may be disposed, with two on the right side and two on the left side. FIG. 12 is a view illustrating the vertical guide module of the lift unit 600 according to the present disclosure. Referring to (a) and (b) in FIG. 12, the vertical guide module may include a vertical guide roller 625 positioned on the moving frame 621 and a vertical guide rail 6552 in contact with the vertical guide roller 625 and coupled to the lower housing 650.

The vertical guide rail 6552 may be disposed to be in contact with the vertical guide rollers 625 on both sides of a vertical guide block 655 that s positioned between the pair of vertical guide rollers.

The vertical guide roller 625 may be fixed to the moving frame 621 to be rotatable about a shaft extending in the horizontal direction, and the pair of vertical guide rollers 625 may be arranged to be spaced apart from each other in a direction perpendicular to the shafts thereof such that the shafts thereof are parallel to each other.

The vertical guide block 655 may further include an auxiliary roller 6533 to prevent friction from occurring at a portion in contact with the first side portion 612 of the upper housing 610.

The vertical guide block 655 according to the present disclosure may include a first guide block 6551 and a second guide block 6555 rotatably coupled as shown in (c) in FIG. 12. The first guide block 6551 is a portion fixed to the lower housing 650, and the second guide block 6555 is a block having the vertical guide rail 6552 while rotatably coupled to the first guide block 6551.

When the vertical guide block 655 is composed of the pair of rotatable guide blocks as such, the first actuator 632a and the second actuator 632b may be independently operated.

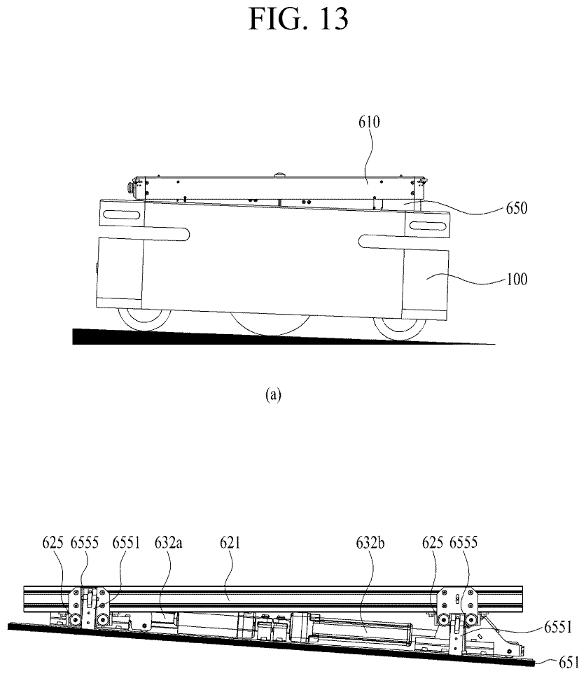

FIG. 13 is a view showing asymmetric operation of the lift unit 600 according to the present disclosure. As shown in (a) in FIG. 13, when the autonomous mobile robot 100 moves along an inclined surface, the top surface of the lift may also be inclined corresponding to the inclined surface. At this time, the article 20 located on the loading structure 10 may fall along the inclined surface, so that the top surface of the lift unit 600 needs to be maintained to be perpendicular to a gravitational direction.

Accordingly, as shown in (a) in FIG. 13, spacings between the upper housing 610 and the lower housing 650 of the lift unit 600 may be different from each other at front and rear sides. A description will be made based on a case of going up the inclined surface. As shown in (b) in FIG. 13, a length of the first actuator 632a located at the front side may be reduced and a length of the second actuator 632b located at the rear side may be increased, so that a moving distance of the vertically moveable structure 620 at the rear side may be increased.

In this regard, the vertical guide block 655 may be inclined obliquely with respect to the vertical guide roller 625 as shown in (b) in FIG. 13. Because locations where the vertical guide roller 625 and the vertical guide rail 6552 are in contact with each other are different from each other at the front and rear sides, a situation in which the vertical guide block 655 does not move on the vertical guide roller 625 may occur.

When the vertical guide module is divided into the two rotatable blocks to allow asymmetrical operation of the actuator 632, an angle between the first guide block 6551 and the second guide block 6555 is increased corresponding to an angle between the base plate 651 and the moving frame 621, thereby offsetting an error resulted from the asymmetrical operation.

On the contrary, in a case of an inclined surface inclined downward, the length of the second actuator 632b positioned at the rear side may be reduced and the length of the first actuator 632a positioned at the front side may be increased, so that the top surface 611 of the upper housing 610 may be horizontal.

As described above, the lift unit according to the present disclosure may transport the loading structure while operating in the horizontal direction using the driving force in the horizontal direction.

The transport robot is able to transport another loading structure even during the time when the article is unloaded after transport of the loading structure, so that efficiency may be improved.

In addition, the upper housing does not ascend obliquely but moves in the vertical direction to uniformly support the load, so that the weight of the loading structure may be stably transported.

Even on the oblique inclined surface, the top surface of the lift unit may be maintained horizontal, thereby preventing the article from falling during the transportation.

The above detailed description is not to be construed as limiting in any respect and should be considered exemplary. The scope of the disclosure is to be determined by a reasonable interpretation of the appended claims, and all changes within the equivalents of the disclosure are included in the scope of the disclosure.

What is claimed is:

1. A lift unit comprising:
a lower housing;
a horizontally moveable structure seated on a top surface of the lower housing;
a vertically moveable structure fastened to the horizontally moveable structure and moveable in a vertical direction when the horizontally moveable structure is operated; and
an upper housing positioned on the vertically moveable structure,
wherein the horizontally moveable structure includes:
a pair of actuators with lengths changing in opposite directions; and
a pair of inclination modules positioned at ends of the pair of actuators, respectively,
wherein the vertically moveable structure includes an inclination roller moveable along an inclined surface of each inclination module.

2. The lift unit of claim 1, wherein the pair of inclination modules include the inclined surfaces directed in opposite directions, respectively,
wherein the lift unit includes a slide roller in contact with the lower housing.

3. The lift unit of claim 2, wherein the vertically moveable structure further includes a roller bracket protruding toward the inclined surface of each inclination module and having the inclination roller coupled to an end thereof.

4. The lift unit of claim 1, wherein the vertically moveable structure includes a pair of vertical guide rollers rotatable about respective shafts thereof parallel to each other,
wherein the lift unit includes a vertical guide block coupled to the lower housing and positioned between the pair of vertical guide rollers.

5. The lift unit of claim 4, wherein the vertical guide block includes:
a first guide block fixed to the lower housing; and
a second guide block including a vertical guide rail engaged with each vertical guide roller and rotatably coupled to the first guide block.

6. The lift unit of claim 5, wherein the first guide block and the second guide block are coupled to each other to be rotatable about a direction perpendicular to an extension direction of each actuator.

7. The lift unit of claim 5, further comprising a controller configured to operate the pair of actuators,
wherein the controller is configured to independently control the length changes of the pair of actuators.

8. The lift unit of claim 7, further comprising a posture sensor configured to sense an inclination of the lower housing,
wherein the controller is configured to control the pair of actuators such that the upper housing is inclined with respect to the lower housing in a direction opposite to a direction of the lower housing inclined with respect to a gravitational direction.

9. The lift unit of claim 1, wherein the upper housing further includes a docking guide pin positioned on a top surface thereof.

10. The lift unit of claim 1, wherein the upper housing further includes a docking guide roller protruding from a corner thereof.

11. The lift unit of claim 1, further comprising a bottom slide roller positioned on a bottom surface of each inclination module and in contact with the lower housing.

12. The lift unit of claim 1, wherein the lower housing includes a horizontal guide rail positioned on a lateral side relative to a movement direction of each inclination module,
wherein the lift unit includes a side slide roller positioned on the lateral side of each inclination module and in contact with the horizontal guide rail.

13. An autonomous mobile robot comprising:
a body including a driving unit; and
a lift unit positioned on top of the body and having a height adjustable in a vertical direction,
wherein the lift unit includes:
a lower housing coupled to an upper portion of the body;
a horizontally moveable structure seated on a top surface of the lower housing;
a vertically moveable structure fastened to the horizontally moveable structure and moveable in a vertical direction when the horizontally moveable structure is operated; and
an upper housing positioned on the vertically moveable structure, wherein the horizontally moveable structure includes:
a pair of actuators with lengths changing in opposite directions; and
a pair of inclination modules positioned at ends of the pair of actuators, respectively,
wherein the vertically moveable structure includes an inclination roller moveable along an inclined surface of each inclination module.
